(19) United States
(12) Patent Application Publication
(10) Pub. No.: US 2016/0253123 A1
(43) Pub. Date: Sep. 1, 2016

(54) NVMM: An Extremely Large, Logically Unified, Sequentially Consistent Main-Memory System

(71) Applicant: Bruce Ledley Jacob, Arnold, MD (US)

(72) Inventor: Bruce Ledley Jacob, Arnold, MD (US)

(21) Appl. No.: 14/662,236

(22) Filed: Mar. 18, 2015

Related U.S. Application Data
(60) Provisional application No. 61/955,250, filed on Mar. 19, 2014.

(51) Int. Cl. G06F 3/06; G06F 12/08

(52) U.S. Cl. CPC G06F 3/0679; G06F 12/0806; G06F 3/0604; G06F 3/0638; G06F 2212/7202; G06F 2212/62

(57) ABSTRACT

Embodiments of both a non-volatile main memory (NVMM) single node and a multi-node computing system are disclosed. One embodiment of the NVMM single node system has a cache subsystem composed of all DRAM, a large main memory subsystem of all NAND flash, and provides different address-mapping policies for each software application. The NVMM memory controller provides high, sustained bandwidths for client processor requests, by managing the DRAM cache as a large, highly banked system with multiple ranks and multiple DRAM channels, and large cache blocks to accommodate large NAND flash pages. Multi-node systems organize the NVMM single nodes in a large inter-connected cache/flash main memory low-latency network. The entire interconnected flash system exports a single address space to the client processors and, like a unified cache, the flash system is shared in a way that can be divided unevenly among its client processors: client processors that need more memory resources receive it at the expense of processors that need less storage. Multi-node systems have numerous configurations, from board-area networks, to multi-board networks, and all nodes are connected in various Moore graph topologies. Overall, the disclosed memory architecture dissipates less power per GB than traditional DRAM architectures, uses an extremely large solid-state capacity of a terabyte or more of main memory per CPU socket, with a cost-per-bit approaching that of NAND flash memory, and performance approaching that of an all DRAM system.

### CROSS-REFERENCES TO RELATED APPLICATIONS

This non-provisional United States (U.S.) patent application claims the benefit of U.S. Provisional Patent Application No. 61/955,250 entitled NVMM: An Extremely Large, Logically Unified, Sequentially Consistent Main-Memory System

### FIELD OF THE INVENTION

The present invention relates to computer memory, and more particularly to a new distributed, multi-node cache and main memory architecture.

### BACKGROUND OF THE INVENTION

Memory systems for large datacenters, such as telecommunications, cloud providers, enterprise computing systems, and supercomputers, are all based on memory architectures derived from the same 1970s era dynamic random access memory (DRAM) organization, and suffer from significant problems because of that DRAM-based memory architecture. These memory systems were never designed, or optimized, to handle the requirements now placed on them: they do not provide high per-socket capacity, except at extremely high price points; they dissipate significant power, on par with the processing components; they are not sequentially consistent and rely upon the processor network to provide both consistency and coherence; and these large data centers are huge, having millions of semiconductor parts, and therefore single device failures are common, requiring the practice of checkpointing, saving a snapshot of the application's state, so that it can restart from that saved state in case of failure.

In these systems, the main memory system was designed to lie at the bottom of the memory hierarchy, with its poor performance hidden by higher-level caches, and when extremely large data sets are streamed out of it, the high-level caches become useless, and the entire system runs at the speed of the slowest component. Thus, tremendous bandwidth is needed to overcome this situation.

Additionally, now that multiprocessor systems are commonplace, it is desirable to use logically unified main memories. But, the existing execution model has each subsystem of main memory attached to a single processor socket, and extra work is required to make the local physical addresses behave as if they were global, and globally unique.

The reason for the power, capacity, and cost problems in these data centers is the choice of DRAM as the main memory for these computing systems. The cheapest, densest, lowest-power memory technology has always been the choice for main memory. But DRAM is no longer the cheapest, the densest, nor the lowest-power storage technology available. It is time for DRAM to go the way that static random access memory (SRAM) went: move out of the way for a cheaper, slower, denser storage technology, and become the choice for cache instead.

There was a time that SRAM was the storage technology of choice for all main memories. However, once DRAM hit volume production in the 1970s and 80s, it supplanted SRAM as a main memory technology because DRAM was cheaper, denser, and ran at a lower power. Though DRAM ran much slower than SRAM, only at the supercomputer level one could one afford to build ever-larger main memories out of SRAM. The reason for moving to DRAM was because an appropriately designed memory hierarchy, built of DRAM as main memory and SRAM as a cache, would approach the performance of SRAM as the main memory, at the price-per-bit of DRAM.

It is now time to revisit the same design choice in the context of modern technologies and modern systems. For both technical and economic reasons, it is no longer feasible to build ever-larger main memory systems out of DRAM.

### SUMMARY

Embodiments of the present invention provide a novel memory-system architecture and multi-node processing having a non-volatile flash main memory subsystem as the byte-addressable main memory, and cache volatile memory front-end for the flash subsystem. Disclosed embodiments reveal a memory-system architecture having many features desirable in modern large-scale computing centers like enterprise computing systems and supercomputers. Disclosed embodiments reveal an extremely large solid-state capacity (at least a terabyte of main memory per CPU socket); power dissipation lower than that of DRAM; cost-per-bit approaching that of NAND flash memory; and performance approaching that of pure DRAM—all in an overall non-volatile memory-system architecture.

One aspect of the present invention is a single node non-volatile main memory (NVMM) system, having a central processing unit (CPU) connected to a NVMM memory controller through a high-speed link, and the NVMM controller connects to a volatile cache memory and a large non-volatile flash main memory subsystem. The NVMM controller manages the flow of data going to and from both the volatile cache memory and non-volatile flash main memory subsystem, and provides access to the memories by load/store instructions. The large flash main memory subsystem is composed of a large number of flash channels, each channel containing multiple independent, concurrently operating banks of flash memory.

A further aspect of the present invention involves storing flash mapping information in a dedicated memory-map portion of the volatile cache memory during system operation, and when the single node NVMM system is powered down, the NVMM controller stores the flash mapping information in a dedicated map-storage location in the non-volatile flash main memory subsystem.

Another aspect of the present invention involves using dynamic random access memory (DRAM) as the volatile cache, and the using NAND flash memory for the non-volatile flash main memory subsystem.

A further aspect of the present invention involves a NAND flash translation layer in the NVMM controller using a dedicated DRAM mapping block to hold the flash translation information. The flash translation layer hides the complexity of managing the large collection of NAND flash main memory devices, and provides a logical load/store interface to the flash devices.

An additional aspect of the present invention has the NVMM controller maintaining a journal in a portion of the NAND flash main memory subsystem. The journal protects the integrity of the NAND flash main memory subsystem files, prevents the NAND flash subsystem from getting into an inconsistent state, maintains a continuous record of changes to files on the NAND flash subsystem, and conducts other journaling operations for the NVMM system, and provides the single NVMM node with automatic checkpoint and restore.

Another aspect of the present invention has the CPU, the NVMM controller, and the high-speed interconnect connecting them packaged on the same integrated circuit (IC).

Still another aspect of the present invention involves the NVMM controller spreading the writes evenly across the NAND flash main memory subsystem, recording the write life-times of all NAND flash memory devices, and marking for replacement any NAND flash memories near the end of their effective lifetime.

An additional aspect of the present invention is the NVMM controller and DRAM cache memory using large memory blocks to accommodate large pages in the NAND flash main memory subsystem.

A further aspect of the present invention is the management of the DRAM cache with large highly banked memory blocks with multiple ranks and multiple DRAM channels, accommodating large NAND flash pages, providing high sustained bandwidths for client processor requests, and filling the DRAM cache blocks with data arriving from the highly banked and multi-channel NAND flash main memory subsystem.

Another aspect of the present invention is the use of a different address-mapping policy for different software applications. These address-mapping policies provide a different memory allocation for each software application active in the CPU and NVMM controller.

Still another aspect of the invention is the use of multi-node computing systems on a printed circuit boards (PCBs), each PCB having multi nodes of computing-memory and memory-controllers, and the nodes of each PCB connect in a Moore-graph topology of n nodes.

A still further aspect of the invention is a rack area network connecting the boards in the rack area networks, inter alia, in a Hoffman-Singleton graph topology.

Another aspect of the invention of the multi-node computing system is software preventing conflicts in the shared multi-node address-mapping policies using policy numbers to map a given address to the various memory resources in each volatile cache memory and the flash main memory subsystems, and allocating different memory resources to different software applications according the memory resource needs of the different software applications.

Finally, another aspect of the present invention is the way the multi-nodes PCBs are connected. Each PCB is connected to a significant number of remote PCBs, having each node on a PCB connect to a different remote PCB, and a first PCB connects, through a plurality of redundant communication links, β to the remote PCBs.

Further applicability of the present invention will become apparent from a review of the detailed description and accompanying drawings. It should be understood that the description central features of the NVMM system and the multi-node computing systems, and the various embodiments disclosed of each are not intended to limit the scope of the invention, and various changes and modifications within the spirit and scope of the invention will become apparent to those skilled in the art. Many substitutions, modifications, additions or rearrangements may be made within the scope of the embodiments, and the scope of the invention includes all such substitutions, modifications, additions or rearrangements.

### BRIEF DESCRIPTION OF THE DRAWINGS

FIG. 1 is a block diagram illustrating the organization of one node non-volatile main memory (NVMM) system according to one exemplary embodiment.

FIG. 2 is a bit level layout diagram of different DRAM cache address-mapping policies according to one exemplary embodiment.

FIG. 3 is a schematic diagram illustrating low-latency ID-vector extraction according to one exemplary embodiment.

FIG. 4 is a block diagram of one embodiment of NVMM selection of address-mapping policies.

FIG. 5 is a block diagram illustrating a multi-node computing and multi-node NVMM memory-system network according to one exemplary embodiment.

FIG. 6 is a diagram illustrating a multi-node board and multi-board rack network organization according to an exemplary embodiment.

FIG. 7 is a diagram illustrating a Petersen graph in multi-node board-area network according to one exemplary embodiment.

FIG. 8 is a diagram illustrating a multi-board rack-area network using the Petersen graph board-area network disclosed in FIG. 7.

FIG. 9 is a series of Peterson graphs demonstrating a link failure in the Peterson graph shown in the FIG. 7 multi-node board-area network.

FIG. 10 is a graph showing a link failure in a Hoffman-Singleton graph, in a multi-rack-area network.

FIG. 11 is a block diagram of a NVMM virtual address according to an exemplary embodiment.

FIG. 12 is a diagram illustrating a NVMM page table according to one exemplary embodiment.

FIG. 13 is a diagram of a 64 kilobyte (KB) virtual page and its eight 8 KB page segments according to one exemplary embodiment.

### DETAILED DESCRIPTION

Revisiting the design choice of ever-larger main memory systems of DRAM, an obvious alternative is NAND flash. In one embodiment, a single node flash-centric memory system is disclosed.

The operating system's file system has traditionally accessed NAND flash memory because NAND flash is a slow, block-oriented device, and the software overheads of accessing it through the file system are small relative to the latency of retrieving data from the flash device. However, if flash were used for main memory, it would be accessed through a load/store interface, which is what main memory demands. For comparison, a file-system access requires a system call to the operating system, a potential context switch, and layers of administrative operations in the operating system—all of which add up to thousands of instructions of overhead; on the other hand, a load/store interface requires but a single instruction: a load or store, which directly reads or writes the main memory, often by way of a cache. Note that NOR flash has been used to implement load/store systems in the past, as NOR flash is many times faster than NAND flash; it is frequently used to replace read-only memories in low-performance embedded systems. NOR flash is also much more expensive than NAND flash, and so it would be desirable to build a main memory out of cheaper, but slower, NAND flash.

Thus, to make NAND flash viable as a main-memory technology, the system must be engineered to allow load/store accesses to flash, and it must hide the large latency difference between DRAM and NAND flash.

Embodiments disclosed below reveal a novel memory-system architecture having a non-volatile flash main memory subsystem as the byte-addressable main memory, and volatile DRAM as the cache front-end for the flash main memory subsystem. Disclosed embodiments reveal a main memory system organized like a storage area network (SAN) where all memory components are interconnected, and the system accepts requests from external client central processing units (CPUs) 2 over high-speed links 4.

Disclosed embodiments reveal a memory-system architecture having many features desirable in modern large-scale computing centers like enterprise computing systems and supercomputers, including support for thousands of directly connected clients; a global shared physical address space, and optional support for a global shared virtual space; a low-latency network with high bi-section bandwidth; a memory system with extremely high aggregate memory bandwidth at the system level; the ability to partition the physical memory space unequally among clients as in a unified cache architecture (e.g., so as to support multiple virtual machines (VMs) in the datacenter); the ability to tailor address-mappings policies to applications; pairwise system-wide sequential consistency on user-specified address sets; and built-in checkpointing through journaled virtual memory.

Embodiments of the single node NVMM system and the multi-node computing system disclosed herein have an extremely large solid-state capacity (at least a terabyte of main memory per CPU socket); a power dissipation lower than that of DRAM; a cost-per-bit approaching that of NAND flash memory; and a performance approaching that of pure DRAM—all in an overall non-volatile memory-system architecture.

The disclosed embodiments of the NVMM single node system architecture supports systems from a single node to thousands of nodes. However, the first disclosed embodiment is a single NVMM node. Distributed, multi-node computing systems are built from multiple single node NVMM systems.

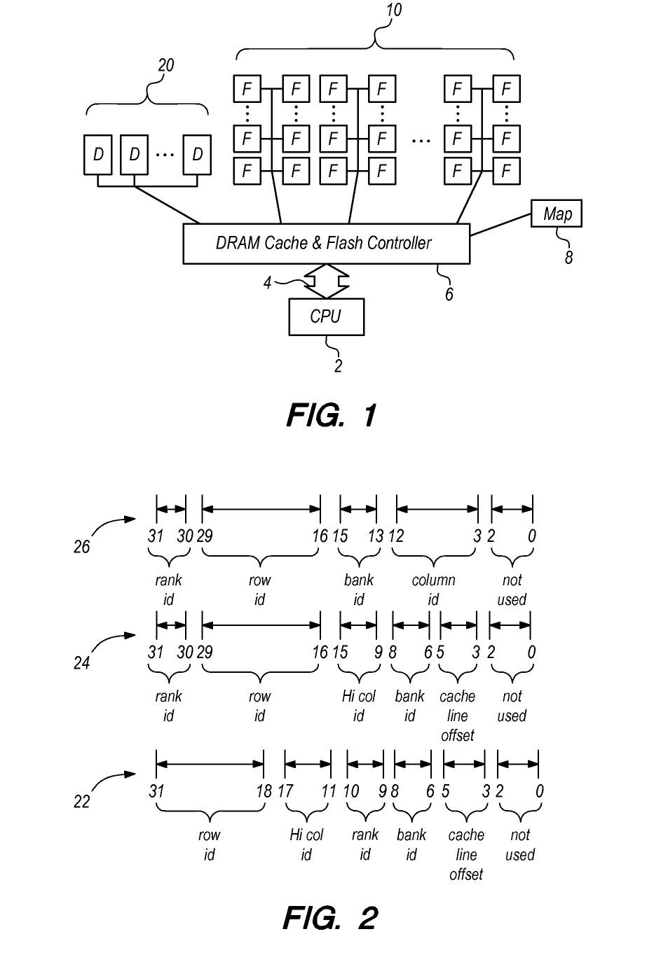

FIG. 1 discloses an embodiment of a single node NVMM system. The CPU 2 connects through a high-speed link 4 to the NVMM DRAM cache and flash main memory subsystem controller 6, which controls both a large, last-level DRAM cache 20 (this particular embodiment illustrates tags held in DRAM, not in SRAM), and the flash main memory subsystem 10. The flash main memory subsystem 10 comprises a large number of flash channels, each channel contains numerous independent, concurrently operative banks Just as like solid-state drives (SSDs), the mapping information 8 is kept permanently in the flash main memory subsystem, and it can be cached in a dedicated DRAM while the system is running, to improve performance. The NVMM controller 6 acts as the flash translation layer for the collection of flash devices 10, and it uses mapping block 8 to hold the translation information for the flash main memory subsystem 10 while running; this mapping information is in effect the system's virtual page table. (A patentee may act as his own lexicographer, MPEP 2173.05(a). Thus, for the purposes of this patent “connected” shall mean a path between two points, regardless of any intervening logic, memory controllers, buffers, etc.]

Also, again similar to SSDs, this embodiment of the single node NVMM system extends the effective write lifetime of the flash main memory subsystem 10 by spreading writes out across numerous flash chips. As individual pages wear out, they are removed from the flash subsystem 10 (marked by the NVMM controller 6 as bad), and the usable storage per flash chip decreases. Pages within a flash device obey a distribution curve in their write lifetimes, some pages wear out quickly, while other pages withstand many more number of writes before they wear out. With a DRAM cache 20 of 32 gigabytes (GB) and a moderate to light application load, a NAND flash main memory subsystem 10 comprising a single 8 GB device would lose half its storage capacity to the removal of bad pages in just under two days and would wear out completely in three days. Thus, a 1 terabyte (TB) NAND flash main memory subsystem 10 comprising 1,000 8 GB flash devices (or an equivalent amount of flash storage having a denser flash memory technology) would, under the same light workload, lose half its capacity in approximately five years and would wear out completely in eight years.

In this embodiment, the DRAM cache 20 uses blocks that are large, to accommodate the large pages used in NAND flash main memory subsystem 10. The DRAM cache 20 is also highly banked, using multiple DRAM channels, each with multiple ranks, providing a high sustained bandwidth for data requests, requests from both the client CPU and requests to fill cache blocks with data arriving from the flash subsystem 10, also highly banked with multi-channels. The size of the cache blocks provides a natural form of sequential prefetching for the application software. Cache design is extremely well known in the field and would be well understood to a person of ordinary skill in the art.

The NVMM controller 6 provides an interface to the system software that allows configuration of its address-mapping facility. This mechanism is used for both DRAM cache 20 and the flash main memory subsystem 10, and the mechanism is general enough to be used in any memory system comprising numerous channels, ranks, banks, or similar facilities (e.g., flash “planes” function like DRAM internal banks) In particular, it is well known that when an address is decomposed into its constituent parts indicating which channel, which bank, which device, which row, which column, etc., the manner in which the decomposition is done can have an order-of-magnitude effect on request latency. This can translate to order-of-magnitude gains or losses in system performance, and so it is extremely important to implement the NVMM address mapping facility well. The difficulty is that every application behaves differently in the way it uses the different memory resources, and so the best memory system design would provide different address-mapping for different applications, or at least provide multiple address-mapping policies for basic differences between the ways that different applications use memory recourses, and in the exemplary disclosed embodiment of the one NVMM node, provision is made for different address-mapping for different applications on an application-by-application basis or a request-by-request basis.

FIG. 2 shows several different address-mapping policies. The address-mapping policy chooses which physical resource corresponds to which bits in the physical address. These examples show a 32-bit physical address mapping onto four ranks (2 bits), each of 8 banks (3 bits), with each row having 16K rows (14 bits), and each row divided into 1024 columns (10 bits). Given an application with largely sequential behavior, the first policy would contain requests within the same row 26; the second policy would spread requests out across different banks of the same DRAM and then at larger granularities would re-use banks 24; the third policy would spread requests out across different banks of the same DRAM and then across different ranks 22.

In the NVMM controller 6, for both DRAM cache 20 and flash main memory 10 access, there is a mapping stage during which a physical address is broken down into resource IDs. In prior-art memory controllers this mapping is hard-coded and there is a single mapping policy for all applications. But in an exemplary embodiment of the disclosed NVMM system, the address mapping is configurable by the system software, and there are multiple choices. In one embodiment, each request to the memory system is accompanied by a 6-bit “policy” identifier, which is broken into two three-bit fields, one for the DRAM mapping policy, and one for the flash mapping policy. The first three bits select one of eight different DRAM mapping policies, and the other three bits select one of eight different flash subsystem mapping policies. In other embodiments, one could implement fewer or more policies, requiring a different number of bits, and one could additionally choose to offer only a single policy for either the DRAM subsystem or the flash subsystem. The operating system (OS) determines what policies best suit a given application, through off-line profiling of application behavior. The OS assigns the application those policies, and transmits the appropriate policy information to the NVMM controller 6 either once at the beginning, during an initialization phase, or only when a policy change is desired, or more frequently, such as whenever the application makes a memory reference. The NVMM controller 6 uses the indicated policies when making memory references on behalf of the application. The system software is responsible for ensuring that shared memory locations operate correctly (i.e., use the same or at least non-conflicting policies). The NVMM controller 6 uses the policy numbers to choose how to map the given address to the various resources in each memory subsystem.

The following function performs the selection of a given address mapping policy:

```
given an incoming physical address ‘P’
for each ID vector ‘V’ (e.g., Channel, Rank, Bank, Row, Column)
      for each bit ‘b’ in that vector
      select the appropriate bit ‘i’ from ‘P’ ... i.e.,
      V[b] <= P[i]
```

The function, represented graphically in FIG. 2, is written algorithmically here to show how to configure address mapping, i.e., it can be performed either by software, by iteration, by simple hardware structures such as programmable logic arrays (PLAs), or banks of multiplexers. Hard-wired implementations simply extract subsets of the incoming address bus by diverting those wires to different locations, and those designs are simple, compact, fast, and require minimal power. The configurable solution simply requires more space, more time, and/or more power.

During an initialization phase, the system software configures the set of mapping policies by sending to the NVMM controller 6 commands that transmit the following information:

| | | |
|---|---|---|
| policy | # | RRrrrrrrrrrrrrrrbbbcccccccccc |
| policy | # | RRrrrrrrrrrrrrrrcccccccbbbccc |
| policy | # | rrrrrrrrrrrrrrcccccccRRbbbccc |

The bus commands allow the individual bits to communicate one at a time, and to indicate bit positions that are out of order. These three example commands implement the mapping policies shown in FIG. 2 (the ‘0’ values at the end are unnecessary and therefore not included). Each command indicates to the NVMM controller that the mapping policy of the indicated number should be configured as indicated. For the DRAM cache, the following characters are used to indicate physical resources:
C channel
R rank
b bank
r row
c column

For the flash main memory subsystem 10, the following characters are used:
C channel
v volume
u unit (i.e., device)
r row (includes plane address bits)
c column

The NVMM controller 6 receives these commands, decodes them, and stores, for each physical device bus, a vector of valid bits that will produce the bus contents. For example, assume the following DRAM mapping policy:
policy mapping rrrrrrrrrrrrcccccccCCRRRbbbbccc

This would correspond to a quad-channel DRAM cache system (two channel bits), each channel of which has 8 ranks (3 rank bits), each rank of which has 16 internal banks (4 bank bits), and so forth. The NVMM controller 6 effectively stores the following information for this policy. For each bit of each ID vector (channel select, rank select, bank select, etc.) the NVMM controller 6 can produce a one-hot bit pattern representing which bit of the incoming physical address ends up routed to that bit of the ID vector. The following are the resulting valid-bit patterns that will ultimately produce each of the resource-select ID vectors:

| C (channel select) = | | | 00000000000000000000110000000000 |
|---|---|---|---|
| | => | C₀ = | 00000000000000000000010000000000 |
| | => | C₁ = | 00000000000000000000100000000000 |
| R (rank select) = | | | 00000000000000000000001110000000 |
| | => | R₀ = | 00000000000000000000000010000000 |
| | => | R₁ = | 00000000000000000000000100000000 |
| | => | R₂ = | 00000000000000000000001000000000 |
| b (bank select) = | | | 00000000000000000000000001111000 |
| | => | b₀ = | 00000000000000000000000000001000 |
| | => | b₁ = | 00000000000000000000000000010000 |
| | => | b₂ = | 00000000000000000000000000100000 |
| | => | b₃ = | 00000000000000000000000001000000 |
| r (row select) = | | | 11111111111110000000000000000000 |
| | => | r₀ = | 00000000000010000000000000000000 |
| | => | r₁ = | 00000000000100000000000000000000 |
| | => | r₂ = | 00000000001000000000000000000000 |
| | => | r₃ = | 00000000010000000000000000000000 |
| | => | r₄ = | 00000000100000000000000000000000 |
| | => | r₅ = | 00000001000000000000000000000000 |
| | => | r₆ = | 00000010000000000000000000000000 |
| | => | r₇ = | 00000100000000000000000000000000 |
| | => | r₈ = | 00001000000000000000000000000000 |
| | => | r₉ = | 00010000000000000000000000000000 |
| | => | r₁₀ = | 00100000000000000000000000000000 |
| | => | r₁₁ = | 01000000000000000000000000000000 |
| | => | r₁₂ = | 10000000000000000000000000000000 |
| c (column select) = | | | 00000000000001111111000000000111 |
| | => | c₀ = | 00000000000000000000000000000001 |
| | => | c₁ = | 00000000000000000000000000000010 |
| | => | c₂ = | 00000000000000000000000000000100 |
| | => | c₃ = | 00000000000000000001000000000000 |
| | => | c₄ = | 00000000000000000010000000000000 |
| | => | c₅ = | 00000000000000000100000000000000 |
| | => | c₆ = | 00000000000000001000000000000000 |
| | => | c₇ = | 00000000000000010000000000000000 |
| | => | c₈ = | 00000000000000100000000000000000 |
| | => | c₉ = | 00000000000001000000000000000000 |

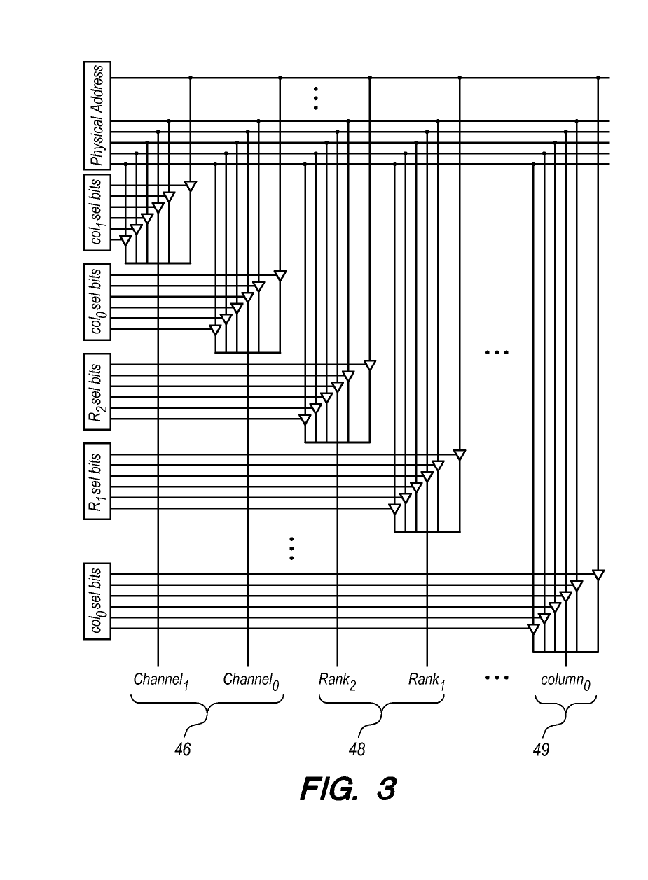

FIG. 3 shows a low-latency ID-vector extraction. A set of valid-bit patterns C1, C0, R2, R1, R0, . . . c1, c0 are fed into a matrix of bit-select primitives (for example, FIG. 3 shows for each a set of tri-state buffers, each of which could also be implemented as single transistors or transmission gates) that map a bit from the incoming address to the corresponding ID vector.

For each bit of a given ID vector (for instance, in the current example, the Channel-select ID 46 vector is two bits; the Rank-select ID 48 vector is three bits; etc.), its corresponding valid-bit pattern drives a set of gates that choose a single bit from the physical address. The single bits are then ganged to produce the ID vector. The structure in FIG. 3 assumes that there is no limitation on which bit of the physical address can produce the bit of the ID vector. It also performs the extraction in a very short latency.

If one assumes that there can be limitations on which bit in the physical address can be used (e.g., a limitation such that rank-select bits may only come from bits in the top half of the address; column-select bits 49 can only come from the bottom half of the address; and so forth), then the logic can be made simpler, as the valid-bit patterns would be smaller, and the number of tri-state buffers would be smaller.

In addition, one could use multi-stage logic to choose the bit patterns, which would require less information to be stored, and less hardware in the select process, at the expense of taking multiple cycles to extract each of the bit patterns. Using this type of logic design, for example, an n-bit ID vector could require as many as n cycles to produce the mapping information, as opposed to the implementation in the figure above, which produces all bits of all bit vectors simultaneously. Design trade-offs between the different exemplary embodiments described above are well known to persons of ordinary skill in the art.

In an NVMM single node embodiment, not all of the address-mapping policies are configurable; several well-known policies already exist in the literature, and in one embodiment the NVMM controller 6 offers hard-wired implementations of these. Hard-wired policies are built-in, and because they are very simple hard-wired circuits, the mapping step takes less time and also requires less energy, as it simply requires routing subsets of the address bus in different directions. System software need only create new mappings for unusual policies, and a running system need only burn extra power and take additional time if unusual policies are desired.

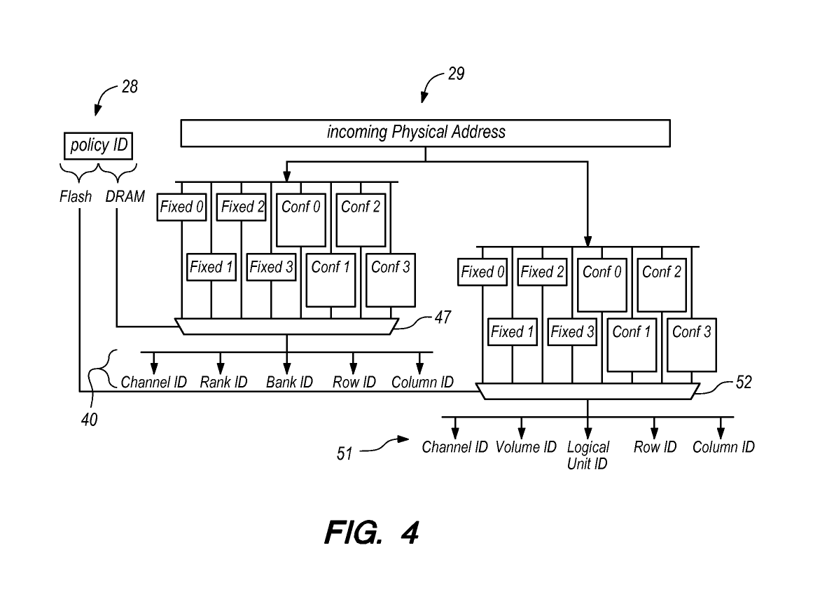

FIG. 4 discloses the selection of address-mapping policies. The incoming physical address 29 is sent to multiple functional mapping units each of which produces a different mapping policy. In this exemplary embodiment, there are eight policies for cache DRAM and eight policies for the flash main memory subsystem, and, for each policy, half are configurable and half are fixed, each producing a resource-vector: the cache DRAM mapping resource-ID vector 40, and the flash mapping resource-ID vector 51. For clarity, FIG. 4 shows all units operative and a final selection through a multiplexer 47, 52. To reduce power, one could enable input only to the desired mapping unit and clock-gate the rest.

FIG. 4 also shows how the six-bit policy identifier 28 is used to choose one of eight different mapping policies for the cache DRAM 20 and the flash subsystems 10. FIG. 4 shows the “Fixed” blocks representing the circuits implemented by hard-wired mapping policies, and the “Conf” blocks represent the circuits implementing configurable mapping policies as illustrated in FIG. 3. Internally, each of the Conf blocks resembles the logic of FIG. 3. Additionally, as with any cache-main memory set, the flash subsystem address-mapping logic is only enabled if reference misses in the DRAM cache 20.

### Multi-Node Computing

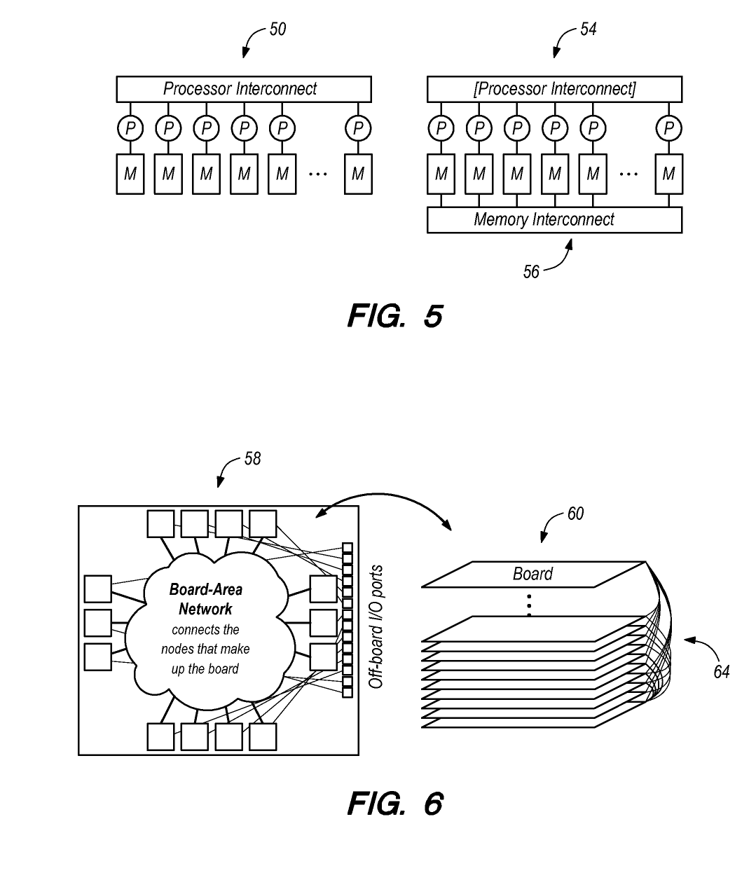

In one embodiment of the present invention a multi-node computer system is disclosed having all the NVMM controllers connected 56, as seen in FIG. 5. Traditional multiprocessors have private memories and a processor network 50. In a multi-node NVMM system, the NVMM controllers are networked and interconnected 56, so data moves through the storage network to reach a requesting client, rather than through the processor network 50.

In a traditional multiprocessor system 50, each processor or processor socket P is the master and controller of its own memory system M, and data in the aggregate memory system is shared between processors by moving it across the processor network. But, as noted, in the multi-node NVMM system, there is a memory network of interconnected controllers 56, and data is moved through this network in response to processor requests. In multi-node NVMM system embodiment, the NVMM controllers could be the sole system interconnect 56, without an explicit processor network 54, or the processor interconnect 54 can be used for other activities such as inter-process communication, messaging, coherency-management traffic, explicit data movement, or system configuration.

The multi-node NVMM network embodiment is designed with computer racks in mind. In particular, in large computing installations, each rack (cabinet) houses a number of circuit boards that are networked together. This organization suggests a natural hierarchy built on the single node NVMM systems: a board-area network 58 and a rack-area network 64 shown in FIG. 6, (and then an inter-rack or inter-cabinet network as well). The rack-area network 64 connects the boards that make up the rack.

Modern server systems are built of racks, each of which is a collection of boards, and this hierarchical arrangement lends itself to a hierarchical network organization. Embodiments of multi-node NVMM networks can use different topologies for the board-area network 58 and the rack-area network 64. Though this is not a limitation of the invention, the multi-node NVMM network embodiments described herein seek to connect as many nodes together as possible, with as short a latency as possible, using the idea behind Moore graphs to construct a multi-hop network that yields the largest number of nodes reachable with a desired maximum hop count (max latency) and a fixed number of input and output (I/O) ports on each controller chip. The resulting board-area network 58 can fit onto a single large PCB within the server rack, though it could also span several smaller boards, for instance within the same cabinet drawer or card cage.

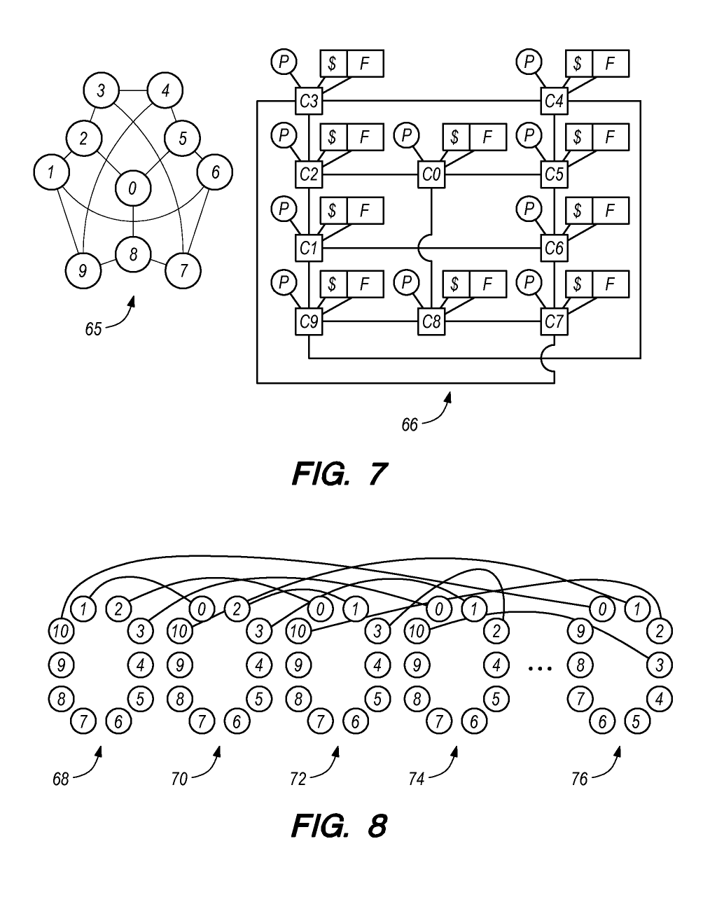

FIG. 7 shows an example NVMM board-area network, a Petersen graph of ten nodes 64, with each NVMM controller chip C0 to C9, offering three network ports, a CPU port P, and a memory ports for DRAM cache $ and the flash main memory subsystem F 66. There could also be a CPU interconnect, not shown.

The Peterson graph of FIG. 7, using the NVMM controller network ports, has a maximum of two hops to reach any node from any other node. Other embodiments NVMM board-area network are readily available, built from more complex networks, limited only by the space on the board, the expense of the PCB, and the number of available I/O ports on the controller chips (the multi-node NVMM embodiment described below requires no special routing and can be built on a simple two-layer board).

The next level of the hierarchy is the rack-area network, which connects the board-area networks, shown in FIG. 8. This multi-node, multi-board embodiment is also based on Moore graphs to create the rack-level network, but it would be undesirable if the number of off-PCB connections were O(n²) per board (n stands for a single node of the network), for a total of O(n³) wires per rack, or if, to accommodate such an interconnect, each board layout would need to be different. While this might be acceptable for small n, such as 100 for a rack-area network of ten boards, each housing a Petersen graph; or even 1000 for a rack-area network of 20 boards, each housing a 50-node network, neither of these scenarios is ideal when dealing with extremely large n (e.g., having to manage 1000 different board designs or 1,000,000 external cables per rack would be difficult). For instance, it is possible to construct an 1850-node system using 37 boards, each of 50 nodes, such that each board uses the same design, and the number of external cables between racks is 1369 (one cable to connect each pair of boards, each cable housing 50 wires, each wire connecting a different pair of nodes). However, if the same size network were implemented poorly, one could require each board to use a different layout (37 different board designs), and the number of external wires between boards could be 80,000, each cable potentially different. Thus, large graphs can be easily decomposed into regular sub-graphs. One of the insights of NVMM is that the most efficient decomposition is into Moore graphs. Therefore, NVMM supports two topologies: one for small n and another for large n.

For small systems, NVMM uses a Moore graph topology across the rack-level network, and, if necessary, different PCB designs for each board. Larger systems are illustrated herein using simple examples for illustrative purposes, such as the 10-node Petersen graph or the 50-node Hoffman-Singleton graph. For large systems, the NVMM multi-node embodiment puts the same board-area network on each board and limits the number of off-PCB connections to O(n). Even though this limits the maximum number of connected nodes, this NVMM multi-node embodiment is a worthwhile trade-off in complexity and manufacturability when dealing with large-scale NVMM systems.

FIG. 8 discloses the interconnection of an NVMM rack-area network 64 (seen in FIG. 6) for large-scale systems. For a given n-node board-area network of h maximum hops, and at least one additional network port on each controller, one can connect n+1 boards in a complete graph, creating a 2h+1 hop network of n²+n nodes.

FIG. 8 shows how one can implement the rack-area network using the same Petersen graph as disclosed in FIG. 7. It is possible to construct, for any n-node board-level network, a rack-area network of n²+n nodes, with each node in the board-area network connecting to a different external board-area network. Thus, a board based on a Petersen graph, with ten nodes per board, would yield a 110-node rack-area network comprising eleven boards. In this example, to help explain the connections, the nodes in Board 0 are labeled 1 . . . 10 (no node 0) 68; the nodes in Board 1 are labeled 0 . . . 10, skipping 1 70; the nodes in Board 2 are labeled 0 . . . 10, skipping 2 72; the nodes in Board 3 are labeled 0 . . . 10, skipping 3; 74; etc. The nodes in Board 10 are labeled 0 . . . 9 (no node 10) 76. For all boards and nodes, the NVMM controller 6 at Board X, Node Y connects to the NVMM controller 6 at Board Y, Node X. Thus, the network can be constructed with exactly n off-board network connections for each board, and each board has identical layout. For a board-area network of two hops, this yields a rack-area network of 2+1+2=5 hops, and each NVMM controller 6 requires four network ports. Note that this is less efficient than the best-known graph with 4 vertices per node and 5 hops: given four ports and 5 hops, one should be able to connect up to 364 nodes, far more than 110. However, for extremely large systems (much larger than this example), the design choice is for simplicity of the PCB design and rack-area interconnect for large n—e.g., using a slightly larger example, for the board-area network the interconnections form a Hoffman-Singleton graph, using seven controller ports to connect 50 nodes in a two-hop board-area network and an eighth port to connect to an off-board node. This yields a rack-area network of 51 boards, for a total of 51 boards per rack, 50 nodes per board, and 2550 total nodes per cabinet. This is compared to the largest known graph of 8 vertices and 5 hops of 5060 nodes, so the trade-off for manufacturability at n=2550 is a factor of two in the maximum number of nodes. Reliability can be increased by providing more or more additional ports per controller, each of which would allow a redundant link between each pair of boards.

If each of the 2550 nodes manages 4 terabytes (TB) of storage, then each board would hold 200 TB of solid-state storage, and each rack would hold 10 petabytes (10 PB). Given that one can fit 4 TB of flash memory, including NVMM controllers, into a volume of approximately 12 cubic inches (the space of four commercial off the shelf (COTS) 1 TB SSDs, which are readily available today, this would easily fit into a modern double-wide cabinet such as IBM's high-performance POWER7 systems (which are 38 inches (in) wide×73.5 in deep, compared to standard racks of 19 in wide×47 in deep); moreover, it could very possibly fit into standard-sized cabinets as well. [Note the space of four COTS 1 TB SSD is a conservative number, based on the Samsung 840 EVO 1 TB SATA III internal drive specifications: 2.75 in×3.94 in×0.27 in equals 2.93 cubic inches. Note also that bare PCBs have significantly less volume (the mSATA Samsung drive is bare-PCB and 1.2 in×2 in×0.15 in); the conservative approach is intended to approximate the extra spacing required for heat.]).

The limiting factor on the size of the racks and cabinets is the spacing required by the heat extraction for the chosen microprocessors and would not be limited by the memory system itself. For example, the disclosed multi-node embodiments would work with low-power embedded CPUs such as 16-core ARM CPUs or 8-core DSPs, [a multi-core processor is a single computing component with two or more independent processing units (called “cores”)] or any other processors that have power envelopes in the low-Watt range—but if one wished to use high-performance CPUs with power envelopes at 100 W or more, one would have to make do with fewer processors, or wider spacing and therefore less memory.

### Routing and Failures

Addressing in the disclosed embodiments of the multi-node computer system is through either static or dynamic routing. Static routing simply uses the node IDs and knowledge of the network topology.

In dynamic routing, during an initialization phase, each NVMM node builds up a routing table with one entry for each NVMM node in the NVMM multi-node system, using a minor variant of well-known routing algorithms. In the NVMM multi-node system, there are two possible dynamic routing algorithms: one for small n and full Moore-graph topologies; another for large n topologies as disclosed in large NVMM multi-node embodiments above.

First, the small n example—this assumes a full Moore graph of p ports and k hops, rack-wide. The routing-table initialization algorithm requires k phases, as follows:

| | |
|---|---|
| phase 1: | send ID to each nearest neighbor |
| | upon receiving p IDs, update table to reflect |
| | topology: |
| | foreach ID { table[ID] = port p } |
| phase 2: | send IDs in table to each nearest neighbor |
| | upon receiving p ID sets, update table to reflect |
| | topology: |
| | foreach ID { if table[ID] empty, table[ID] = port p } |
| . . . | |
| phase k: | send IDs table to each nearest neighbor |
| | upon receiving p ID sets, update table to reflect |
| | topology |
| | foreach ID { if table[ID] empty, table[ID] = port p } |

At each phase, each node receives p sets of IDs, each set on one of its ports p. This port number represents the link through which the node can reach that ID. The first time that a node ID is seen represents the lowest-latency link to reach that node, and so if a table entry is already initialized, it need not be initialized again (doing so would create a longer-latency path).

For large n, the table-initialization algorithm takes into account the number of redundant channels between each pair of boards. For a board-level topology of n nodes, each of which has p ports, we choose a 2-hop network, and so the table-initialization algorithm requires two phases to initialize the entire rack network. This is because, in the large-n system, each node ID contains both a board ID and a node ID unique within that board. The algorithm:

| | |
|---|---|
| phase 1: | send ID [board #, node #] to each nearest neighbor |
| | upon receiving p IDs, update table to reflect |
| topology: | |
| | foreach ID |
| | if ID is on local board |
| | table[ID] = port p |
| | else |
| | b = board number for node ID |
| | for all nodes n on board b, table[n] = p |
| phase 2: | send nearest-neighbor IDs only to neighbors on same |
| board | |
| | upon receiving p ID sets, update table to reflect |
| topology: | |
| | foreach ID |
| | if ID is on local board |
| | if table[ID] empty, table[ID] = port p |
| | else |
| | b = board number for node ID |
| | for all nodes n on board b, table[n] = p |

As mentioned earlier, reliability can be increased by providing an additional port per controller, which would allow a redundant link between each pair of boards.

In the case of node/link failures for each of the system topologies (small and large), when a node realizes that one of its links is dead (there is no response from the other side), it broadcasts this fact to the system, and all neighboring nodes update their table temporarily to use random routing when trying to access the affected nodes. The table-initialization algorithm is re-run as soon as possible, with extra phases to accommodate for the longer latencies that will result with one or more dead links. If the link is off-board in the large-scale topology, then the system uses the general table-initialization algorithm of the small-scale system.

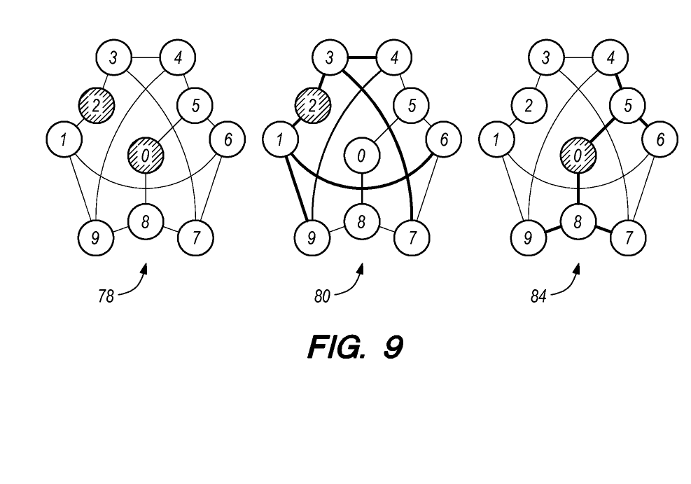

FIG. 9 shows a Peterson graph network link failure, and when a single link fails, only adjacent nodes and the nodes nearest neighbors are affected. In general, the redundancy of networks based on Moore graphs is similar to other topologies such as meshes. When a link goes down, all nodes in the system are still reachable; the latency simply increases for a subset of the nodes, as seen in the Petersen graph embodiment in FIG. 9. Suppose the link between the center node 0 and node 2 goes down 78. When sending to or from node 2 80, the only nodes affected are node 0 and its remaining nearest neighbors. When sending to or from node 0 84, the only nodes affected are node 2 and its nearest neighbors. All other communication proceeds as normal, with the normal latency. During link failure, the affected nodes simply require an additional hop, or two in the case of sending between the two nodes immediately adjacent to the failed link.

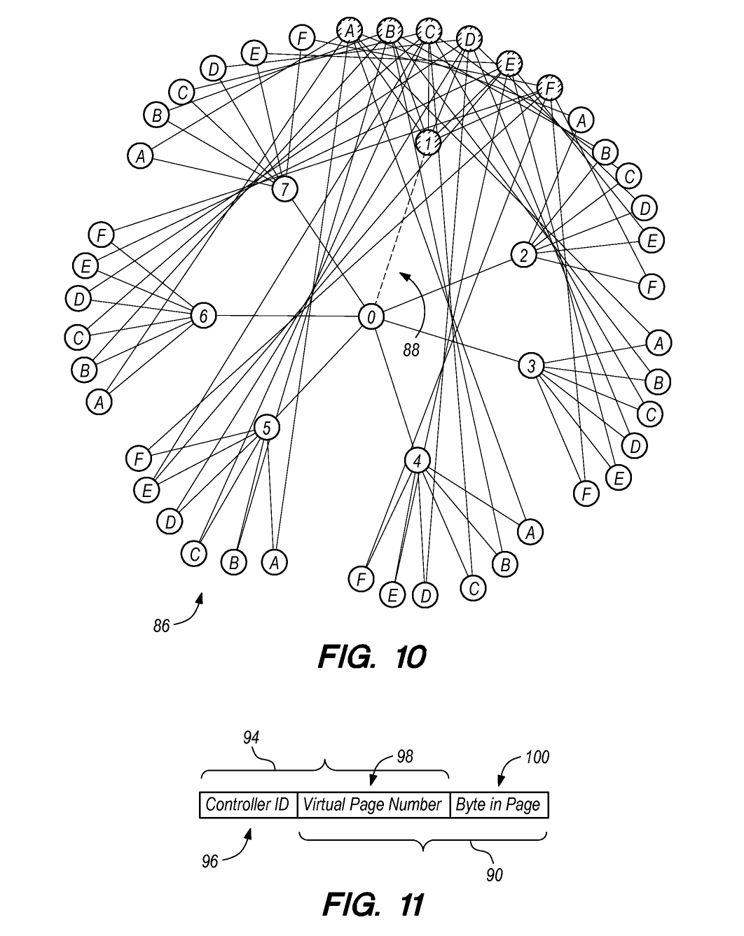

FIG. 10 shows a link failure in a Hoffman-Singleton Graph configuration 86. Only the relevant subsets of the inter-node links are shown. Assume the link between nodes 0 and 1 88 goes down. Node 1 and its remaining nearest neighbors are shown in slightly hashed nodes; node 0 and its remaining nearest neighbors are shown in unmarked nodes. Node 0 is still connected in two hops to every node but node 1 and the A-F nodes that are nearest neighbors to node 1 (the hashed nodes). The 36 unmarked nodes labeled A to F have not been affected. Similarly, communications between the nearest neighbors of 0 and the nearest neighbors of 1 has not been affected, as noted, only communications involving either node 0 or node 1 are affected, communication between node 0 and 1 can be through any path out of node 0 or node 1 (thus the use of random routing in the case of link failure) and is increased from 2 hops to 4. Communications between node 0 and the remaining nearest neighbors of 1, or between node 1 and the remaining nearest neighbors of 0, requires three hops; like communication between nodes 0 and 1, it can be take by any path, one can see, for example, that to get from node 0 to node A in node 1's neighbors (the node A that is shaded dark grey), one can go via node 2, 3, 4, 5, 6 or 7, and still require a latency of three hops. The overhead is relatively low, and this is easily seen in the larger-scale graph.

### The NVMM Software Interface

The flash main memory subsystem 10 is non-volatile and journaled. Flash memories in general do not allow write-in-place, and so to over-write a page one must actually write the new values to a new page. Thus, the previously written values are held in a flash device until explicitly deleted—this is the way that all flash devices work. NVMM exploits this behavior by retaining the most recently written values in a journal, preferring to temporarily retain the recently overwritten page instead of immediately marking the old page as invalid and deleting its block as soon as possible.

The NVMM system exports its address space as both a physical space (using flash page numbers) and as a virtual space (using byte-addressable addresses). Thus, a NVMM system can choose to use either organization, as best suits the application software. This means that software can be written to use a 64-bit virtual address space that matches exactly the addresses used by NVMM to keep track of its pages. FIG. 11 illustrates an example address format that allows the address to be used by a CPU's virtual memory system directly, if so desired. The 48-bit block address 94 allows up to 256 trillion pages to be managed system-wide. The top 20 bits 96 specify a home controller for each page, supporting up to 1M separate controllers. Each controller can manage up to 16 TB of virtual storage 90, in addition to several times that of versioned storage. As defined by the 16-bit page offset, 64 KB pages are used, which is independent of the underlying flash page size. Note that two controller ID values are special: all 0s and all 1s, which are interpreted to mean local addresses, i.e., these addresses are not forwarded on to other controllers.

This organization allows compilers and operating systems either to use this 64-bit address space directly as a virtual space, i.e., write applications to use these addresses in their load/store instructions, or to use this 64-bit space as a physical space, onto which the virtual addresses are mapped. Moreover, if this space is used directly for virtual addresses, it can either be used as a single address space OS organization, in which software on any CPU can in theory reference directly any data anywhere in the system, or as a set of individual main-memory spaces in which each CPU socket is tied only to its own controller.

NVMM exports a load/store interface to application software, which additionally includes a handful of mechanisms to handle non-volatility and journaling. In particular, it implements the following functions:
alloc. Equivalent to malloc( ) in a Unix system—allows a client to request a page from the system. The client is given an address in return, a pointer to the first byte of the allocated page, or an indication that the allocation failed. The function takes an optional Controller ID as an argument, which causes the allocated page to be located on the specified controller. This latter argument is the mechanism used to create address sets that should exhibit sequential consistency, by locating them onto the same controller.
read. Equivalent to a load instruction. Takes an address as an argument and returns a value into the register file. Reading an as-yet-un-alloc'ed page is not an error, if the page is determined by the operating system to be within the thread's address space and readable. If it is, then the page is created, and non-defined values are returned to the requesting thread.
write. Equivalent to a store instruction. Takes an address and a datum as arguments. Writing an as-yet-un-alloc'ed page is not an error, if the page is determined by the operating system to be within the thread's address space and writable. If it is, then the page is created, and the specified data is written to it.
delete. Immediately deletes the given flash page from the system.
setperms. Sets permissions for the identified page. Among other things, this can be used to indicate that a given temporary flash page should become permanent, or a given permanent flash page should become temporary. Note that, by default, non-permanent pages are garbage-collected upon termination of the creating application. If a page is changed from permanent to temporary, it will be garbage-collected upon termination of the calling application.
sync. Flushes dirty cached data from all pages out to flash. Returns a unique time token representing the system state.
rollback. Takes an argument of a time token received from the sync function and restores system state to the indicated point.

### A Page Table Organization for NAND-Flash Main Memory

When handling the virtual mapping issues for a flash-based main memory system 10, there are several things that differ dramatically from a traditional DRAM-based main memory. Among them are the following:
The virtual page number that the flash system exports is smaller than the physical space that backs it up. In other words, traditional virtual memory systems use main memory as a cache for a larger virtual space, so the physical space is smaller than the virtual space. In NVMM, because flash pages cannot be overwritten, previous versions of all main memory data are kept, and the physical size is actually larger than the virtual space.
Because the internal organization of the latest flash devices changes over time, in particular, block sizes and page sizes are increasing with newer generations, one must choose a virtual page size that is independent of the underlying physical flash page size. So, in this section, unless otherwise indicated, “page” means a virtual-memory page managed by NVMM.

The NVMM flash controller 6 requires a page table that maps pages from the virtual address space to the physical device space and also keeps track of previously written page data. The NVMM system uses a table that is kept in flash 8 but can be cached in a dedicated DRAM table while the system is operating. The following exemplary embodiment demonstrates one possible table organization. Each entry of the exemplary page table contains the following data:

| | | |
|---|---|---|
| 34 | bits | Flash Page Mapping (channel, device, block, and starting |
| | | page) |
| 30 | bits | Previous Mapping Index-pointer to entry within page table |
| 32 | bits | Bit Vector-Sub-Page Valid Bits & Remapping Indicators |
| 24 | bits | Time Written |
| 8 | bits | Page-Level Status & Permissions |
| 16 | Bytes | Total Size |

The flash-page-mapping locates the virtual page within the set of physical flash-memory channels. In this example, a page must reside in a single flash block, but it need not reside in contiguous pages within that block.

The previous-mapping-index is a pointer to the table entry containing the mapping for the previously written page data. The time-written value keeps track of the data's age, for use in garbage-collection schemes.

The sub-page-valid-bits and remapping-indicators is a bit-vector that allows the data for a 64 KB page to be mapped across multiple page versions written at different times. It also allows for pages within the flash block to wear out.

The virtual-page-number is used directly as an index into the table, and the located entry contains the mapping for the most recently written data. As pages are overwritten, the old mapping info is moved to other free locations in the table, maintaining a linked list, and the indexed entry is always the head of the list.

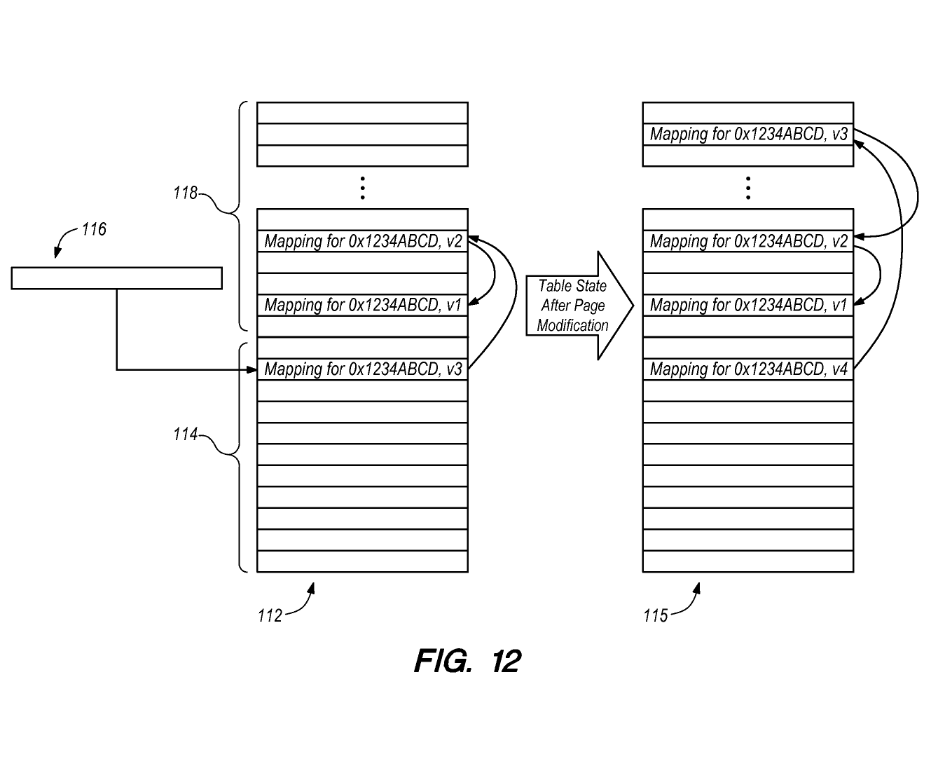

FIG. 12 illustrates an update to this example NVMM page table. A NVMM system uses a table 112 that stores mappings for previously written pages 118 as well as the most recent 114. Each virtual page number (VPN) 116 is a unique index to the table and references the page's primary entry; if older versions of the page exist, this primary entry points to them. Topmost entries 118 of table 112 hold mappings for previous version of pages. A virtual page number of 28-bits is an index 116 into the bottom 256M table entries 114, which require 4 GB of storage, and the rest of the table holds mapping entries for previously written versions of pages.

When the primary mapping is overwritten, its data is copied to an empty entry in the table, and it is updated to hold the most recent mapping information as well as linking to the previous mapping information.

When new data is written to an existing virtual page, flash memory requires the new data to go to a new flash page. This data will be written to a flash page found on the free list maintained by the flash controller (identical to the operation currently performed by a flash controller in an SSD), and this operation will create new mapping information for the page data. This mapping information must be placed into the table entry for the virtual page. Instead of deleting or overwriting the old mapping information, and placing the old page on the free list to be garbage-collected, the NVMM page table keeps the old information in the topmost portion of the table, which cannot be indexed by the virtual page number (which would otherwise expose the old pages directly to application software via normal virtual addresses). When new mapping data is inserted into the table, it goes to the indexed entry, and the previous entry is merely copied to an available slot in the table. Note that the pointer value in the old entry is still valid even after it is copied. The indexed entry is then updated to point to the previous entry. The example previous-mapping-index is 30 bits, for a maximum table size of 1B entries, meaning that it can hold three previous versions for every single virtual page in the system. The following pseudo-code indicates the steps performed when updating the table on a write-update to an already-mapped block:

```
existing mapping entry is at index VPN
find a new, available entry E in the top section of the table
copy existing mapping information from entry #VPN into entry #E
      i.e., table[E] <- table[VPN]
write “E” into table[VPN].previousMappingIndex
find free page N in flash system (N={chan|volume|LUN|block|page})
write dirty data from 64K page to flash pages N..N+7 at 8K granularity
table[VPN].flashPageMapping = N
table[VPN].bitVector = set to indicate which 8K chunks were written
      (data from all other chunks are in previously written pages)
table[VPN].timeWritten = now( )
```

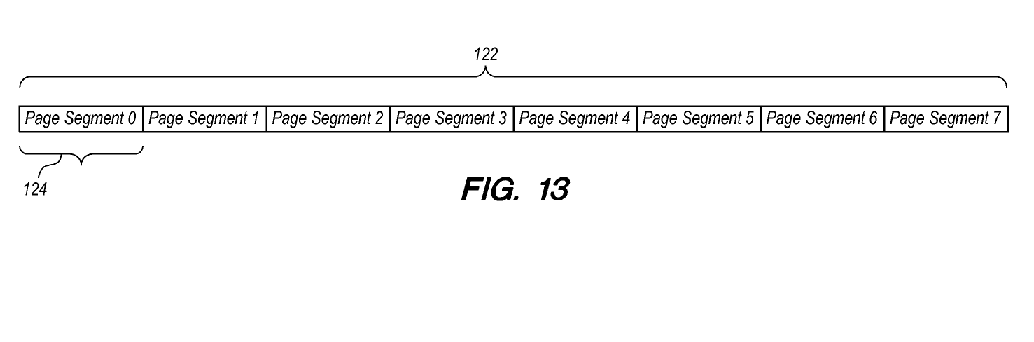

FIG. 13 shows an example 64 KB virtual-page and its eight 8 KB page-segments. The size of the page segment is chosen to correspond to the flash page size and can be 4K, 8K, 16K, etc. The virtual-page-size is 64 kilobyte (KB) 122, and pages are written to flash at an 8 KB granularity 124 (or 16 KB if the flash page size is 16 KB). The 8 KB sections are called page segments, and also are illustrated in FIG. 13.

This suggests a bit-vector of 8 bits, but the bit-vector data structure in the example page table entry is 32 bits, not 8. This is an optimization chosen to support multiple features: it keeps track of data even if there are worn-out pages in the flash block, and it allows for page data to be spread out across multiple flash blocks, so as to avoid re-writing non-dirty data. This support, for this embodiment, is described below.

If all the data in a virtual-page is in the cache and is dirty, for example, say this is the first time that the virtual-page is written, then all 64 KB would be written to eight consecutive flash pages in the same flash block, and the first 8 bits of the bit-vector area would be set to “1,” the remaining 24 set to a value of “0” as follows (spaces inserted every 8 bits to show 64 KB-sized page groupings):
11111111 00000000 00000000 00000000

If, however, one or more of the flash pages in the first eight has exceeded its write endurance and is no longer usable, or if it is discovered to be “bad” when it is written, then the flash page cannot be used. In this scenario, the controller will make use of the pages at a distance of eight away instead, or at a distance of 16, or 24. The 32-bit vector allows each 8 KB page-segment of the 64 KB virtual-page to lie in one of four different locations in the flash block, starting at the given flash page-number offset within the block (note that the flash page number within the flash block need not be a power of 32). In this scenario, say that there are two bad flash pages in the initial set of eight, at the positions for page segments 3 and 6, but the other pages are free, valid, and can be written. Assume also that the starting-flash-page-number is 53, thus, flash pages 56 and 59 within the given flash block are worn out and cannot be written, but pages 53, 54, 55, 57, 58, and 60 can be written. The controller cannot write the data corresponding to page segment 3 to flash page 56, and so it will attempt to place the data at flash-page numbers 64, 72, and 80; assume that page 64 is available, writable, and can accept data. The controller cannot write the data corresponding to page segment 6 to flash page 59, and so it will attempt to place the data at flash-page numbers 67, 75, and 83; assume that page 67 already has data in it and that page 75 is available, writable, and can accept data. Then, once the data is written to the flash pages and the status confirmed by the controller, the bit-vector is set to the following:
11101101 00010000 00000010 00000000

The next time that data is written to this page and must be written back from the cache, suppose that not all 64 KB is “dirty” data—not all of it has been written. Assume, for example, that only page-segments 2 and 5 have been modified since the previous write-out to main memory. Only these page-segments should actually be written to flash pages, as writing non-dirty data is logically superfluous (the previous data is still held in the table) and also would cause pages to wear out faster than necessary. In this scenario, a new location in the flash subsystem is chosen, representing a different device and a different block number. Suppose that the starting-flash-page-number is 17 and that both pages 19 and 22 in this block are valid. The data corresponding to page segment 2 is written to flash page 19; the data corresponding to page segment 5 is written to flash page 22; and the bit-vector for the operation is set to the following:
00100100 00000000 00000000 00000000
   As flash blocks become fragmented (the pages in the blocks will not be written consecutively when the 64 KB virtual pages start to age), the controller can exploit the bit-vector. In the previous example, the controller would only need to find free writable pages at one of several possible distances from each other within the same flash block:

| | | | | |
|---|---|---|---|---|
| distance 3 | 00100100 | 00000000 | 00000000 | 00000000 |
| distance 5 | 00000100 | 00100000 | 00000000 | 00000000 |
| distance 11 | 00100000 | 00000100 | 00000000 | 00000000 |
| distance 13 | 00000100 | 00000000 | 00100000 | 00000000 |
| distance 19 | 00100000 | 00000000 | 00000100 | 00000000 |
| distance 21 | 00000100 | 00000000 | 00000000 | 00100000 |
| distance 27 | 00100000 | 00000000 | 00000000 | 00000100 |

When a flash block needs to be reclaimed, in most cases it means that multiple page-segments need to be consolidated. This entails reading the entire chain of page-table entries, loading the corresponding flash pages, and coalescing all of the data into a new page. This suggests a natural page-replacement policy in which blocks are freed from the longest chains first. This frees up the most space in one replacement and also improves performance in the future by reducing the average length of linked lists that the controller needs to traverse to find cache-fill data.

As disclosed above, this new NVMM single and multi node embodiments are a vast improvement in savings of power, capacity, and cost over prior art single node and multi-node memory systems. The disclosed NVMM multi-node embodiments revealed a novel distributed cache and flash main memory subsystem supporting thousands of directly connected clients, a global shared physical address space, a low-latency network with high bi-section bandwidth, a memory system with extremely high aggregate memory bandwidth at the system level, and the ability to partition the physical memory space unequally among clients as in a unified cache architecture. The disclosed NVMM systems revealed extremely large solid-state capacity of at least a terabyte of main memory per CPU socket, power dissipation lower than that of DRAM, cost-per-bit approaching that of NAND flash memory, and performance approaching that of pure DRAM.

Although the present invention has been described with reference to preferred embodiments, numerous other features and advantages of the present invention are readily apparent from the above detailed description, plus the accompanying drawings, and the appended claims. Those skilled in the art will recognize that changes may be made in form and detail without departing from the spirit and scope of the disclosed invention.

What I claim is:

1. A single node non-volatile main memory (NVMM) system, comprising:
a central processing unit (CPU);
the CPU connected to a NVMM controller through a high-speed link;
the NVMM controller connected to a volatile cache memory and a large non-volatile flash main memory subsystem, and providing access to the memories by load/store instructions;
the large flash main memory subsystem comprising a large number of flash channels, each channel containing multiple independent, concurrently operating banks of flash memory.

2. The memory system of claim 1, wherein the NVMM controller maintains flash mapping information in a dedicated memory-map portion of the volatile cache memory during system operation; and when the single node NVMM system is powered down, the NVMM controller stores the flash mapping information in a dedicated map-storage location in the non-volatile flash main memory subsystem.

3. The single node NVMM system of claim 2, wherein the volatile cache memory is dynamic random access memory (DRAM) and the non-volatile flash main memory subsystem is NAND flash memory.

4. The single node NVMM system of claim 3, wherein the NVMM controller provides a flash translation layer for a collection of flash devices in the NAND flash main memory subsystem, using a DRAM mapping block to hold the flash translation information, a virtual page table of the single node NVMM system, providing a logical load/store interface to the NAND flash devices.

5. The single node NVMM system of claim 4, wherein the NVMM controller maintains a journal in a portion of the NAND flash main memory subsystem, the journal protecting the integrity of the NAND flash main memory subsystem data, maintaining a continuous record of changes to data on the flash subsystem, and providing the node with automatic checkpoint and restore.

6. The single node NVMM system of claim 1, wherein the CPU, the NVMM controller, and the high-speed interconnect connecting them are packaged in the same integrated circuit.

7. The single node NVMM system of claim 1, wherein the NVMM controller is implemented as a plurality of integrated circuits.

8. The single node NVMM system of claim 5, wherein the NVMM controller records the write life-times of NAND flash memory devices, and marks for replacement NAND flash memories near the end of their effective lifetime.

9. The single node NVMM system of claim 1, wherein the NVMM controller and DRAM cache memory use large memory blocks to accommodate large pages in the NAND flash main memory subsystem.

10. The single node NVMM system of claim 3, wherein the DRAM cache has large highly banked memory blocks with multiple ranks and multiple DRAM channels, accommodating large NAND flash pages, and the controller fills the DRAM cache blocks with data arriving from the highly banked and multi-channel NAND flash main memory subsystem.

11. The single node NVMM system of claim 1, wherein, prior to the use of a specific application software, an address-mapping policy is selected for the specific application software according to the way the specific application software uses the memory system, and during use of the specific application software, the NVMM controller uses the address-mapping policy of the specific application software to allocate memory resources for the specific application software, using a plurality of address-mapping policies during operation.

12. A computer system wherein, prior to the use of a specific application software, an address-mapping policy is selected for the specific application software according to the way the specific application software uses the memory system, and during operation, the computer system uses a plurality of address-mapping policies.

13. The single node NVMM system of claim 12, wherein each specific application software data request to the NVMM controller is accompanied by a multi-bit policy identifier, the multi-bit policy identifier contains a plurality of fields, one for selecting a volatile cache memory mapping policy, and one for selecting a flash main memory subsystem mapping policy.

14. A computer system wherein one or more application software memory requests are accompanied by a policy identifier, the policy identifier selects between a plurality of address-mapping policies implemented by the memory controller.

15. The computer system of claim 14, wherein at least one address-mapping policy is hardwired and non-hardwired bits in the address-mapping policy bits of an address are used for configurable address-mapping policies.

16. A multi-node computer system comprised of multiple, interconnected, printed circuit boards (PCBs), each PCB having a board-area network of nodes, and each node connected in a Petersen graph topology, all nodes of the Petersen graph reachable by two node hops, and each node in the Petersen graph having three network ports.

17. A multi-node computer system comprising multiple, interconnected, clusters of nodes, the nodes of the computer system connected in a Moore graph topology and each cluster of nodes having a local network of connections connected in a smaller Moore-graph topology.

18. The multi-node computer system of claim 17, having five PCBs, the nodes of each PCB connected in a Petersen graph topology, and the fifty nodes of the five boards connected in a Hoffman-Singleton graph topology.

19. The multi-node computer system of claim 17, having eleven PCBs, the nodes of each PCB connected in a Petersen graph topology, and the ten nodes of a first PCB connected to a node on a different PCB.

20. The multi-node computer system of claim 17, having eleven PCBs, the nodes of each PCB connected in a Petersen graph topology, and the nodes of each PCB connected to a node on a different PCB, and a plurality of redundant communication links inter-connecting the PCBs.

21. A multi-node computer system comprised of multiple interconnected PCBs, each PCB having a board-area network of inter-connected nodes, and all the nodes of the PCBs connected in a Hoffman-Singleton graph topology.

22. The multi-node computer system of claim 21, having fifty-one PCBs, the nodes of each PCB connected in a Hoffman-Singleton graph topology, and the fifty-one PCBs connected such that each node on a first PCB connects to a node on a different PCB.

23. The multi-node computer system of claim 21, having fifty-one PCBs, the nodes of each PCB connected in a Hoffman-Singleton graph topology, the fifty-one PCBs having each node on a first PCB connects to a node on a different PCB, and a plurality of redundant communication links inter-connect the PCBs.

24. A multi-node PCB computer system comprised of multiple interconnected PCBs, the nodes of each PCB connected in a Moore-graph topology of n nodes.

25. The multi-node computer system of claim 24, wherein the nodes of each PCB connect to the nodes of a different PCB, from the set of PCBs of the multi-node computer system.

26. The multi-node computer system of claim 24, wherein each node on a PCB connects to a different PCB, and a plurality of redundant communication links inter-connect the complete set of PCBs.
